(19) United States
(12) Patent Application Publication
(10) Pub. No.: US 2013/0328407 A1
(43) Pub. Date: Dec. 12, 2013

(54) WIRELESS POWER TRANSMISSION APPARATUS, WIRELESS POWER TRANSMISSION SYSTEM, AND WIRELESS COMMUNICATION APPARATUS

(71) Applicant: Canon Kabushiki Kaisha, Tokyo (JP)

(72) Inventor: Hajime Shimura, Tokyo (JP)

(21) Appl. No.: 13/911,381

(22) Filed: Jun. 6, 2013

(30) Foreign Application Priority Data
Jun. 8, 2012 (JP) 2012-131054

(51) Int. Cl. H02J 7/02

(52) U.S. Cl. CPC H02J 7/025
USPC 307/104

(57) ABSTRACT

A magnetic body is arranged between a coil and a housing of a wireless power transmission apparatus configured to perform wireless power transmission with another apparatus. A manner of the layout is such that a plurality of faces of material is facing a plurality of faces of the housing of the wireless power transmission apparatus.

### BACKGROUND OF THE INVENTION

1. Field of the Invention

The present invention relates to a wireless power transmission apparatus, and more particularly, to a configuration for mounting a coil on a wireless power transmission apparatus.

2. Description of the Related Art

Methods for wirelessly transmitting power include an electromagnetic induction method, a magnetic field resonance method, an electric field coupling method, and a radio wave receiving method. The electromagnetic induction method and the magnetic field resonance method each transmit power using an inductive coupling between coils mounted on respective devices. The electric field coupling method transmits power using a capacitive coupling between capacitances mounted on respective devices. The radio wave receiving method transmits and receives radio waves between antennas mounted on respective devices to transmit power.

In the above-described wireless power transmission, unlike a case of performing power transmission via a wired connection between the devices, it is important to maintain power transmission efficiency because power is transmitted and received via a space. In a power transmission apparatus using inductive coupling between the coils like the electromagnetic induction method or the magnetic field resonance method, a configuration for improving power transmission efficiency by arranging a magnetic body for strengthening the coupling between the coils near the coils is discussed (for example, Japanese Patent Application Laid-Open No. 11-260658, Japanese Patent Application Laid-Open No. 2010-239848).

Further, in Japanese Patent Application Laid-Open No. 2011-119872, a degree of freedom of layout with an opposing apparatus is improved by arranging a rectangular solid magnetic body, dielectric or conductor between a housing of an apparatus that performs communication or wireless power transmission using a high-frequency coupler having a planar coupling electrode, and the coupling electrode

Further, a configuration for efficiently performing positioning between the coils in order to maintain power transmission efficiency is discussed in, for example, Japanese Patent Application Laid-Open No. 2009-81946.

In the electromagnetic induction method/magnetic field resonance method for the wireless power transmission system as described above, transmitting and receiving of power between the power-transmitting and power-receiving apparatuses is performed using electromagnetic field generated via the coils. In this case, even when the power transmitting apparatus and the power receiving apparatus are arranged in a short distance to each other, unless the coils on the power transmitting side/power receiving side are facing each other, and respective coils overlap to a certain degree, power transmission efficiency will be heavily deteriorated. This is because, on the power transmitting side, the magnetic field (magnetic flux) is generated to penetrates the power transmitting side coil, and therefore unless the coils on the power transmitting side/power receiving side are facing each other, and the coils overlap each other to a certain degree, the effect is not generated on the power receiving side coil.

Further, in order to provide a wide chargeable layout location of the power receiving apparatus with respect to the power transmitting apparatus, for example, a plurality of power transmitting coils is mounted on the power transmitting apparatus, alternatively, a structure for causing the power transmitting coils to move to a position at which they are facing the power receiving coils of the power receiving apparatus must be mounted. However, a structure for improving a degree of freedom of layout of the power-transmitting and power-receiving apparatuses in performing such the wireless power transmission cannot be necessarily provided with the above-described structure, due to constraints in sizes or costs of products themselves of the power-transmitting and power-receiving apparatuses. Further, in Japanese Patent Application Laid-Open No. 2009-81946, although flexibility of layout between the apparatuses that perform transmission using planar coupling electrodes is improved, a configuration for improving flexibility of layout of the power-transmitting and power-receiving apparatuses at the time of the wireless power transmission using the coils is not taken into consideration.

### SUMMARY OF THE INVENTION

The present invention is directed to putting flexibility into layout of power-transmitting and power-receiving apparatuses when performing wireless power transmission, and to enabling to efficiently perform power transmission.

According to an aspect of the present invention, a wireless power transmission apparatus configured to perform wireless power transmission with other apparatus, the apparatus includes a coil configured to perform wireless power transmission, and a magnetic body configured to be arranged such that at least a portion thereof penetrates an interior of the coil, wherein a plurality of faces of the magnetic body is arranged to be facing a plurality of faces of a housing of the wireless power transmission apparatus.

Further features and aspects of the present invention will become apparent from the following detailed description of exemplary embodiments with reference to the attached drawings.

### BRIEF DESCRIPTION OF THE DRAWINGS

FIG. 1 is a diagram illustrating a configuration of electromagnetic induction method/magnetic field resonance method.

FIG. 2 is a diagram illustrating configurations of electromagnetic induction method/magnetic field resonance method when a magnetic body is arranged.

FIGS. 3A and 3B each illustrate a power transmitting cradle, and a coil and a magnetic body with which a power receiving device (such as a digital camera) is equipped.

FIG. 4 is a configuration diagram of a wireless power transmission system in a first exemplary embodiment.

FIGS. 5A, 5B, and 5C each illustrate an orientation of a power transmitting cradle and a digital camera that enables wireless power transmission in the first exemplary embodiment.

FIGS. 6A, 6B, and 6C each illustrate an orientation of a power transmitting cradle and a digital camera that is not suitable for wireless power transmission in a second exemplary embodiment.

FIG. 7 is a control flowchart of a digital camera 102.

FIG. 8 is a wireless power transmission system configuration diagram in a third exemplary embodiment.

FIGS. 9A, 9B, and 9C each illustrate an orientation of digital cameras that enables wireless power transmission in the third exemplary embodiment.

FIG. 10 is a wireless power transmission system configuration diagram in a fourth exemplary embodiment.

FIGS. 11A and 11B each illustrate coils arranged with rectangular magnetic bodies.

FIGS. 12A, 12B, 12C, 12D, 12E, and 12F each illustrate an orientation of digital cameras that enables wireless power transmission in the fourth exemplary embodiment.

FIGS. 13A, 13B, and 13C each illustrate an orientation of digital cameras that is not suitable for wireless power transmission in a fifth exemplary embodiment.

FIG. 14 is a control flowchart of a digital camera 201.

FIG. 15 is a diagram illustrating a coil arranged with a hemispherical magnetic body.

FIGS. 16A and 16B are hardware configuration diagrams of a power transmitting cradle and a digital camera.

FIG. 17 illustrates a coil loaded with a magnetic body that enables configuration of closed loop.

FIGS. 18A and 18B each illustrate a state where magnetic bodies each enabling formation of a closed loop are loaded, in each of the power transmitting and receiving systems.

### DESCRIPTION OF THE EMBODIMENTS

A first exemplary embodiment will be described.

Hereinbelow, exemplary embodiments in the present invention will be described while referring to the drawings. In the present exemplary embodiment, a wireless power transmission system using an electromagnetic induction method or a magnetic field resonance method for transmitting power via coils will be described by way of example. The scope of application of the present invention includes not only within a range of the electromagnetic induction method or the magnetic field resonance method, but also can be applied to a wireless power transmission systems of different wireless power transmission method using coupling between the coils.

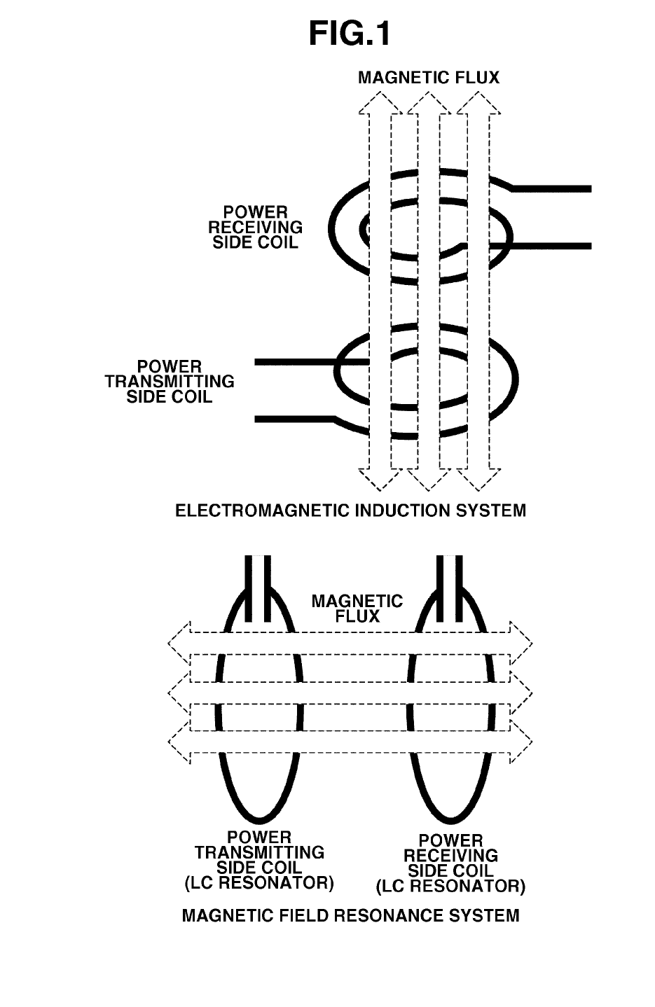

FIG. 1 illustrates configuration examples of the electromagnetic induction method/magnetic field resonance method. The electromagnetic induction method transmits power using an induced electromotive force generated by inductive coupling between the coils. The magnetic field resonance method allows both the power transmitting and receiving apparatuses to constitute an LC resonator with coil and capacitance and allow electromagnetic fields to be coupled in a resonance state between the resonators to transmit power. As illustrated in FIG. 1, when the coils of each of the power-transmitting and power-receiving apparatuses are arranged facing each other, inductive coupling between the coils is strengthened, and power can be efficiently transmitted between the two coils. In order to strengthen the inductive coupling between the coils of the power-transmitting and power-receiving apparatuses, the coils facing each other need to overlap to some extent. Further, the inductive coupling between the coils is inversely proportional to a distance between the coils. Therefore, if the coils of the power-transmitting and power-receiving apparatuses are not facing each other, and positioning is not appropriately performed, the transmission characteristics will deteriorate, and the power transmission will not be performed. Further, as the distance between the coils is increased, the transmission characteristics will deteriorate, and the power transmission will be disabled.

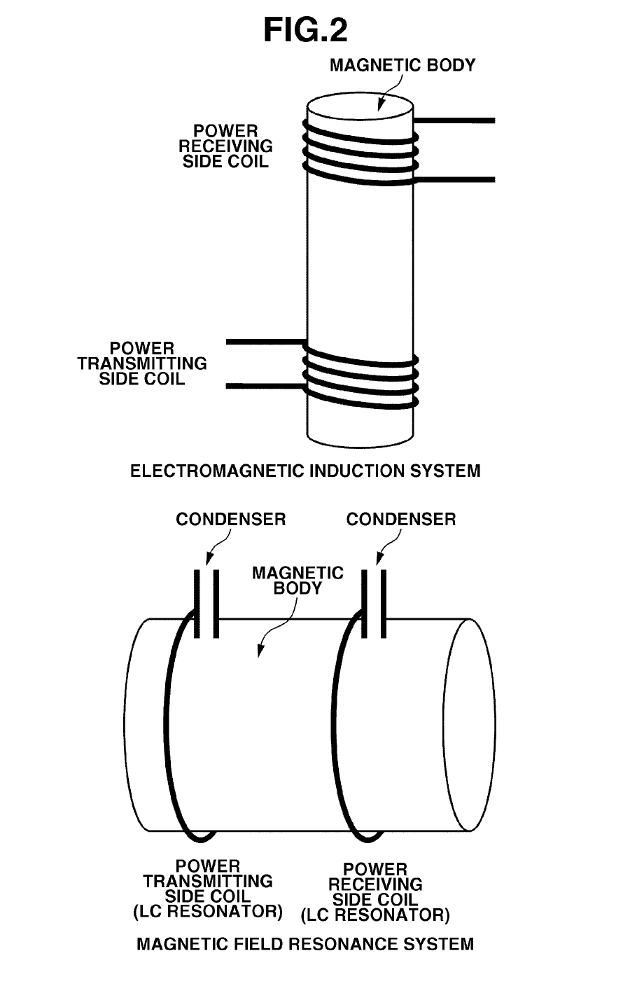

FIG. 2 illustrates configuration examples of the electromagnetic induction method/magnetic field resonance method in which magnetic bodies are arranged (loaded). As illustrated in FIG. 2, when the magnetic body is loaded between the coils, magnetic flux can be concentrated inside the magnetic body, and as a result, coupling between the coils can be strengthened, and the power can be efficiently transmitted. In the present exemplary embodiment, by using the above-described principle, favorable transmission characteristics is maintained, and a degree of freedom of apparatus layout is improved when power transmission is performed between the wireless power transmission apparatuses having the coils. Further, an example in which power transmission can be performed even if the coils do not face each other, and an example in which power transmission can be performed, even if the coils overlap to a less degree, or do not overlap at all, will be described.

In the present specification of the invention, “arranging (loading) a magnetic body on coils” refers to arranging a magnetic body in contact with or in close proximity to coils, in order to reduce deterioration of the transmission characteristics of an electromagnetic field which the coils transmit or receive.

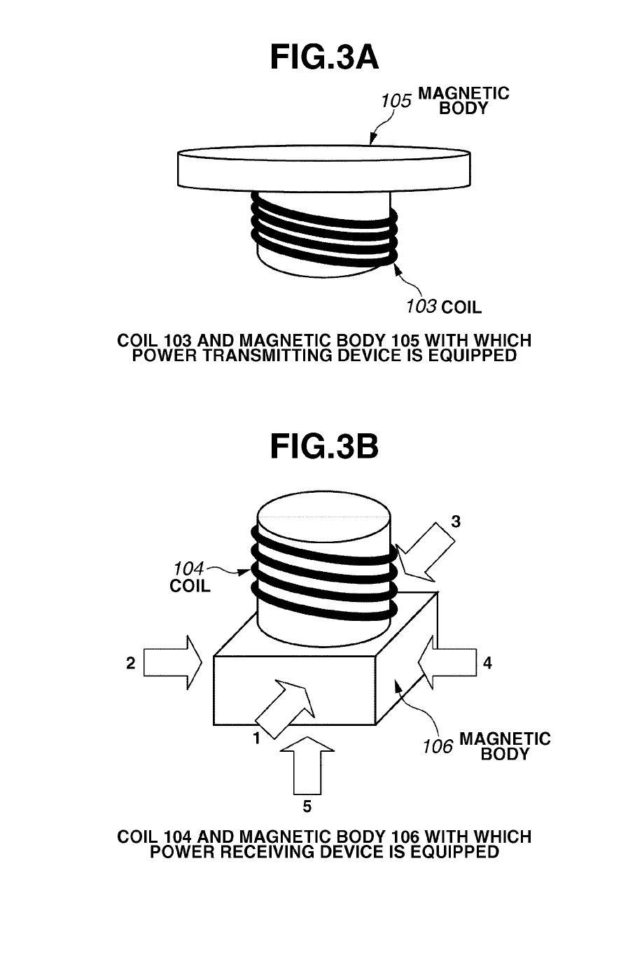

A power transmitting unit provided in the power transmitting apparatus and a power receiving unit provided in the power receiving apparatus in the present exemplary embodiment using the principle illustrated in FIG. 2 that the magnetic body concentrates a magnetic flux in the inside (forms a magnetic path) will be described with reference to FIGS. 3A and 3B. FIG. 3A is a diagram illustrating a state where a magnetic body 105 is loaded on a coil 103 with which the power transmitting apparatus in the present exemplary embodiment is equipped. An electromagnetic field generated by the coil 103 is propagated via the magnetic body 105, and the electromagnetic field is further generated from a face of the magnetic body 105. FIG. 3B is a diagram illustrating a state where a magnetic body 106 having a rectangular solid shape is loaded on a coil 104 with which the power receiving apparatus in the present exemplary embodiment is equipped. Further, an electromagnetic field generated by the power transmitting apparatus is input from either face of the magnetic body 106 of the power receiving apparatus, and is directed to the coil 104 via the magnetic body 106. By loading the rectangular solid magnetic body on the power receiving coil on the power receiving apparatus side in this manner, even when an electromagnetic field from the power transmitting apparatus is input from any face of 1 through 5 of the magnetic body 106, the magnetic body 106 results in forming a magnetic path that penetrates the interior of the coil 104. In other words, wireless power transmission can be performed while maintaining favorable transmission characteristics, even when the coil on the power transmitting side faces any face of 1 through 5 of the magnetic body 106. Even when direct inductive coupling between the coil 103 and the coil 104 is weak (when the coil 103 and the coil 104 are not facing each other not to overlap each other to some degree), the wireless power transmission can be performed while maintaining favorable transmission characteristics. This is because the magnetic field concentrates inside the magnetic body, and the magnetic body forms the magnetic path, whereby the inductive coupling between the coils is strengthened.

In other words, conventionally, the coils needed to face each other while they are overlapping, but even when the coils do not necessarily overlap each other, or do not face each other, the wireless power transmission can be performed. In other words, flexibility, and a degree of freedom of layout of the power receiving apparatus with respect to the power transmitting apparatus when the wireless power transmission is performed can be improved. The magnetic body 106 has a rectangular solid body and a protruding portion which protrudes from a portion of the rectangular solid body, and has a structure in which the protruding portion is provided inside the coil 104. However, the magnetic body 106 is not limited to this, but the magnetic body 106 is acceptable as long as it has such a structure that forms the magnetic path inside the coil 104, and strengthens an inductive coupling between the coils of the power-transmitting and power-receiving apparatuses, even when an electromagnetic field generated from the power transmitting apparatus is received from each of a plurality of faces of the housing of the power receiving apparatus.

As long as the effect of forming the magnetic path by concentrating the magnetic field generated from the coils is obtained, the magnetic body 106 may be in contact with the coil, or arranged in the neighborhood, but as the distance from the coil increases, the transmission characteristics deteriorates, and accordingly it is advantageous for the magnetic body 106 to be in contact with the coil. Further, it is advantageous to constitute the coil 104 by winding an electric wire over a portion of the magnetic body 106 (configuration in which at least a portion of the magnetic body 106 is inserted into the coil). In the example illustrated in FIG. 3B, the coil 104 is constituted by winding the electric wire over the protruding portion that protrudes from the rectangular solid body of the magnetic body 106.

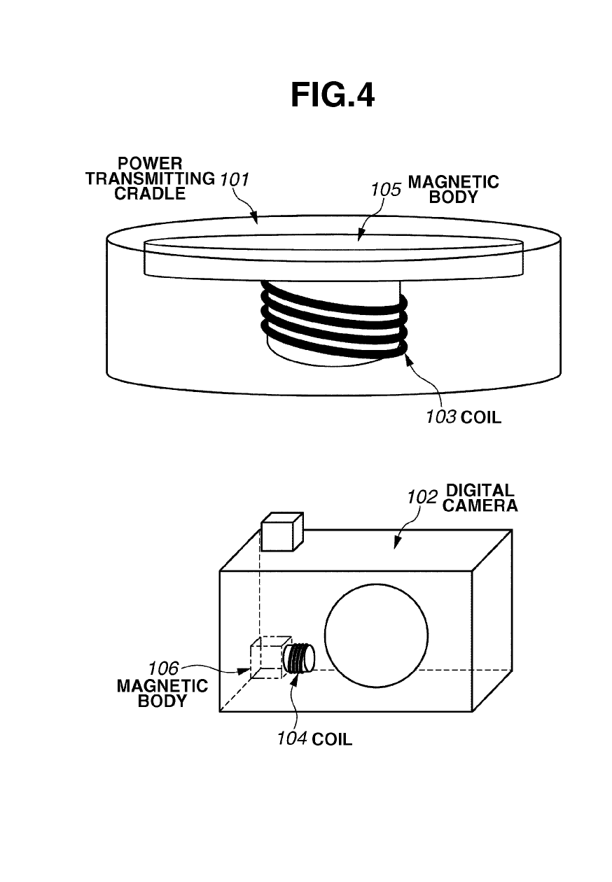

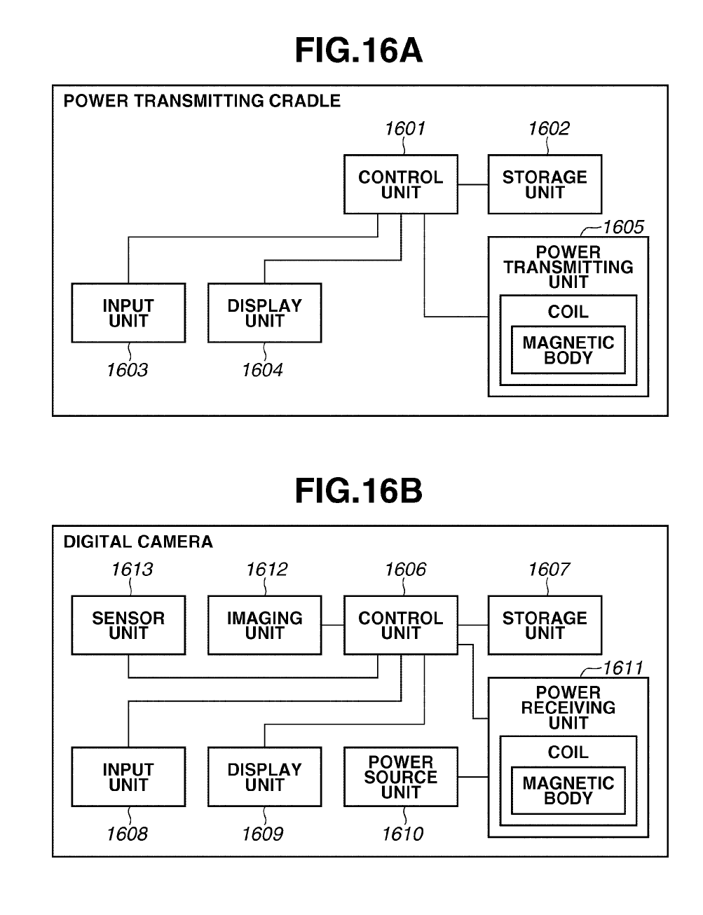

Subsequently, the wireless power transmission system according to the present exemplary embodiment will be described. FIG. 4 is a diagram illustrating the wireless power transmission system according to the present exemplary embodiment. In the present exemplary embodiment, a case of performing the wireless power transmission between a power transmitting cradle 101 (the power transmitting apparatus) on the power transmitting side, and a digital camera 102 (the power receiving apparatus) on the power receiving side is considered. The hardware configuration of the power transmitting cradle 101, and the digital camera 102 are illustrated in FIGS. 16A and 16B.

FIG. 16A illustrates a configuration of the entire power transmitting cradle. A control unit 1601 controls the entire apparatus that executes control programs stored in a storage unit 1602. The storage unit 1602 stores the control programs executed by the control unit 1601 and various types of information. Various types of operations described below are performed by the control unit 1601 executing the control programs stored in the storage unit 1602. An input unit 1603 is used when a user performs various types of inputs. A display unit 1604 performs various types of displays such as a liquid crystal display (LCD) or a light-emitting diode (LED) that has a function of enabling output of visually recognizable information, or such as a speaker enabling sound output. A power transmitting unit 1605 performs power transmitting to the power receiving apparatus. The power transmitting unit 1605 includes the coil 103 and the magnetic body 105 which have been illustrated in FIG. 3A.

FIG. 16B illustrates a configuration of the entire digital camera. A control unit 1606 controls the entire apparatus by executing control programs stored in a storage unit 1607. The storage unit 1607 stores the control programs executed by the control unit 1606, and various types of information. Various types of operations described below are performed, by the control unit 1601 executing the control programs stored in the storage unit 1607. An input unit 1608 is used when the user performs various types of inputs. A display unit 1609 performs various types of displays such as LCD or LED that has the function of enabling output of visually recognizable information, or such as a speaker enabling sound output. A power receiving unit 1611 charges a power source unit 1610 by the power wirelessly transmitted from the power transmitting apparatus. The power receiving unit 1611 includes the coil 104 and the magnetic body 106 illustrated in FIG. 3B. An imaging unit 1612 outputs a subject light which has entered via a lens as image data. A sensor unit 1613 detects an orientation of the digital camera using an output of a gyro sensor for detecting an angle or angular velocity of an object. The sensor unit 1613 is used in the second exemplary embodiment and onward.

In FIG. 4, the magnetic body 105 of the power transmitting cradle 101 having the above-described configuration is arranged to cover from the inside entire faces where the digital camera 102 (the power receiving apparatus) is placed. At least in one side face of the housing of the power transmitting cradle 101 for placing the power receiving apparatus, the magnetic body 105 is set up to be facing the side face within a predetermined distance from any position of the side face. The magnetic body 105 is brought into contact with or into close proximity to a face of the power transmitting cradle 101 where the digital camera 102 is placed (hereinafter, referred to as chargeable face), whereby wireless power transmission to the digital camera 102 becomes able to be efficiently performed in any position on a chargeable face of the power transmitting cradle 101. A face of the magnetic body 105 which is in contact with or in close proximity to the chargeable face is configured to be larger than the coil 103, and a portion of the magnetic body 105 is configured to penetrate the coil 103. In the present exemplary embodiment, the coil 103 is configured by winding an electric wire on a part (protruding portion) of the magnetic body 105. Therefore, since the electromagnetic field generated by the coil 103 is generated from any position of a face which is in contact with the chargeable face of the magnetic body 105, wireless power transmission can be performed without being aware of positioning between the power receiving coil of the power receiving apparatus and the coil 103 of the power transmitting cradle 101.

The digital camera 102 is equipped with the above-described coil 104 and the magnetic body 106 having a rectangular solid body portion for concentrating the magnetic field generated from the coil. The magnetic body 106 is arranged between the housing and the coil 104. Further, the magnetic body 106 has a rectangular solid body and a protruding portion which protrudes from the rectangular solid body, and the protruding portion is configured to penetrate the interior of the coil 104. In the present exemplary embodiment, the coil 104 is configured by winding an electric wire on a portion of (protruding portion) the magnetic body 106. Therefore, the electromagnetic field input into the magnetic body 106 is concentrated on the protruding portion, which forms a magnetic path such as the one which penetrates the interior of the coil 104. Further, the magnetic body 106 is arranged to come into contact with a plurality of faces of the housing of the digital camera 102. More specifically, if either face of a plurality of faces of the housing which comes into contact with each of a plurality of faces of the magnetic body 106 is brought into contact with the chargeable face of the power transmitting cradle 101, the magnetic body 106 is arranged so that the digital camera 102 can be efficiently charged. Further, a face of the magnetic body 106 which is in contact with or in close proximity to the housing of the digital camera 102 while being opposed thereto is larger than the coil 104. Therefore, a degree of freedom can be put into positioning between the coil 104 and the power transmitting coil 103 of the power transmitting apparatus.

In FIG. 4, an example in which the magnetic body 106 is in contact with a back surface, a right surface, and a bottom surface of the housing is illustrated, but the magnetic body 106 may be in contact with (in close proximity to) other faces. The magnetic body 106 may not be necessarily in contact with the housing, but since the transmission characteristics deteriorates as a distance from the housing increases, it is advantageous that the magnetic body 106 is in contact with or in close proximity to the housing. By arranging the magnetic body 106 so that a corner of the housing of the power receiving apparatus and a corner of the magnetic body 106 come into contact with (in close proximity to) each other, more faces are allowed to become a face facing the power transmitting apparatus when wireless power transmission is performed. The close proximity refers to being within a range in which the wireless power transmission can be realized. Further, the close proximity refers to being within a range in which the wireless power transmission can be realized while meeting the predetermined transmission efficiency, in a case where wireless power transmission is performed from the power transmitting apparatus having the predetermined transmission characteristics. The predetermined transmission efficiency may be specified, based on a charging amount (power receiving efficiency) per unit time, or time taken until full-charging is reached. In other words, when the wireless power transmission is performed by bringing a face which is in contact with or in close proximity to the magnetic body 106 of faces of the housing of the power receiving apparatus, into contact with the power transmitting cradle 101, the predetermined transmission efficiency is met. On the other hand, when the wireless power transmission is performed by bringing a face which is neither in contact with nor in close proximity to the magnetic body 106 (of the faces of the housing, a face other than the faces which are in contact with or in close proximity to the magnetic body 106) of the faces of the housing of the power receiving apparatus, into contact with power transmitting cradle 101, it can be said that the predetermined transmission efficiency is not met.

A case where wireless power transmission is performed between the power transmitting cradle 101 having the above-described structure and the digital camera 102 is considered. In the example of FIG. 4, the magnetic body 106 of the digital camera 102 is in contact with the back surface, the right surface, and the bottom surface of the housing. Therefore, if the back surface, the right surface, and the bottom surface of the digital camera 102 is arranged in the chargeable face (face which is in contact with the magnetic body 105) of the power transmitting cradle 101, an inductive coupling between the coils can be strengthened, and power transmission with favorable transmission characteristics can be performed.

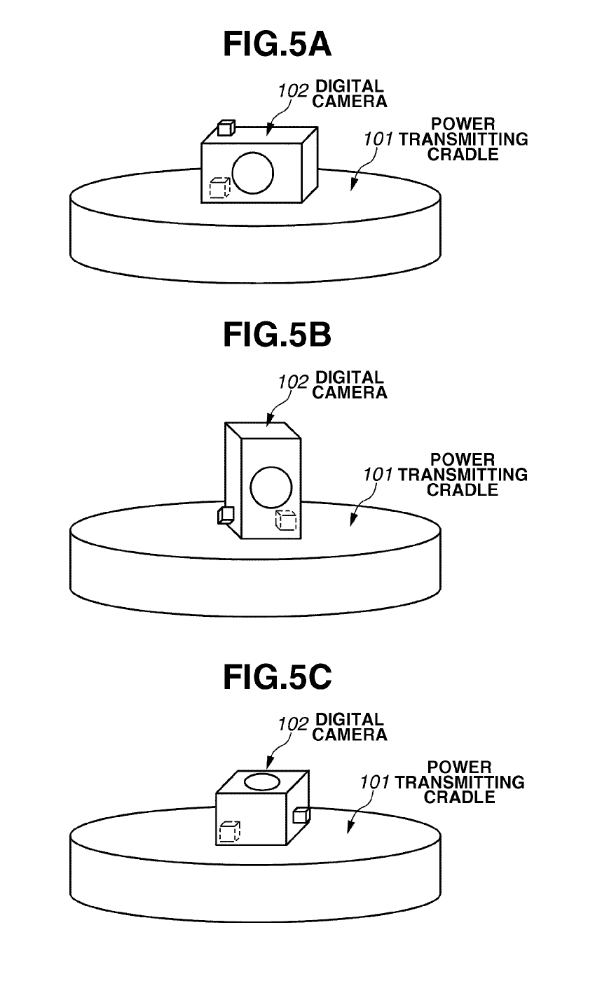

FIGS. 5A through 5C are layout examples in which the power transmitting cradle 101 and the digital camera 102 can perform power transmission. In FIG. 5A, by mounting the bottom surface (face with which the magnetic body 106 comes into contact) of the digital camera 102 on the chargeable face of the power transmitting cradle 101, the magnetic body 105 of the power transmitting cradle 101 and the magnetic body 106 of the digital camera 102 are brought into close proximity to each other while facing each other. In that case, the coil 103 and the coil 104 turn out to be positional relationship in which they are not facing each other, but rather orthogonal to each other. However, the magnetic body 106 can strengthen an inductive coupling between the coils, and can perform power transmission with favorable transmission characteristics, by forming a magnetic path such as the one that directs an electromagnetic field emitted by the power transmitting cradle 101 to the coil 104. In FIG. 5B, by mounting the right surface of the digital camera 102 on the chargeable face of the power transmitting cradle 101, the magnetic body 105 of the power transmitting cradle 101 and the magnetic body 106 of the digital camera 102 are brought into close proximity to each other while facing each other. In FIG. 5C, by mounting the back surface of the digital camera 102 on the chargeable face of power transmitting cradle 101, the magnetic body 105 of power transmitting cradle 101 and the magnetic body 106 of the digital camera 102 are brought into close proximity to each other while facing each other. As illustrated in FIG. 5A through 5C described above, by placing the digital camera 102 on the power transmitting cradle 101, an electromagnetic field generated by the power transmitting cradle 101 (an electromagnetic field generated by the coil 103 via the magnetic body 105) is directed to the coil 104 via the magnetic body 106 of the digital camera 102. Then, the digital camera 102 can perform charging using power generated by the electromagnetic field directed to the coil 104.

As described above, by arranging the coil 104 loaded on the wireless power transmission apparatus and a plurality of faces of the magnetic body 106 having the effect of concentrating the magnetic field generated from the coil to form a magnetic path so as to be in contact with or in close proximity to a plurality of faces of the housing of the apparatus, it becomes possible to perform wireless power transmission even when the coils on the power transmitting side and the power receiving side are not facing each other. In other words, by providing a rectangular solid body portion like the magnetic body 106, and by arranging a plurality of faces of the rectangular solid body portion so as to be in contact with or in close proximity to a plurality of faces of the housing of the wireless power transmission apparatus, a plurality of faces which is facing an partner apparatus and enables to perform favorable wireless power transmission can be provided. Further, the wireless power transmission apparatus according to the present exemplary embodiment, is configured to arrange a magnetic body between the coil and the housing, so that the magnetic path formed by the magnetic body is configured to penetrate the interior of the coil. Further, by providing a protruding portion in which a portion of the magnetic body protrudes, and by the protruding portion existing (being inserted) inside the coil, the magnetic path as described above can be formed. Further, an electromagnetic field input from either face of the rectangular solid body portion of the magnetic body acts to generate power on the coil, thereby flexibility, and a degree of freedom can be put into layout between the apparatuses that performs wireless power transmission. Further, by arranging in the coils the magnetic body 105 of which faces being in contact with or in close proximity to the housing of the wireless power transmission apparatus are larger than the coils and the magnetic body 106, favorable wireless power transmission in which transmission efficiency is hardly impaired without the need to strictly perform an positioning of the coils between the apparatuses can be performed.

As described above, according to the present exemplary embodiment, even a layout between the apparatuses in which the coils on the power transmitting side and power receiving side are not opposed to each other, or even an layout in which an positioning of the coils (the centers of the coils are overlapped, the coils are overlapped each other to some extent) between the apparatuses is not strictly performed, allows the wireless power transmission to be performed. That is, flexibility, and a degree of freedom can be put into an layout between the apparatuses that perform wireless power transmission.

In the present exemplary embodiment, the magnetic body 105 is loaded on the power transmitting cradle 101, but in a case without the magnetic body 105, if the digital camera 102 is placed immediately above the coil 103 in orientations of FIG. 5A through 5C, wireless power transmission can be efficiently performed.

Further, a shape of the magnetic body does not need to be a rectangular solid body, and if it is a shape conformed to a shape of the housing of the wireless power transmission apparatus, it is only necessary to place the magnetic body so that a plurality of faces of the magnetic body having the effect of forming the magnetic path by concentrating the magnetic field generated from power transmitting and receiving coils comes into contact with or into close proximity to a plurality of faces of the housing. In other words, if a shape of the housing is a rectangular solid body as illustrated in FIG. 4, layout of the magnetic body can be facilitated when the magnetic body is formed into the rectangular solid body.

Further, it may be configured such that the magnetic body 106 is added to the power transmitting coils of the power transmitting apparatus, and a plurality of faces of the magnetic body is arranged so as to be facing a plurality of faces of the housing. In other words, by configuring the chargeable faces of the power transmitting apparatus on a multiple-faces basis, flexibility, and a degree of freedom can be put into a layout between the apparatuses that perform wireless power transmission, even when the power receiving apparatus does not have the magnetic body 106. Further, it may be configured such that the power receiving coil of the power receiving apparatus is equipped with the magnetic body 105 as illustrated in FIG. 3A. By configuring in this manner, a degree of freedom of appropriate layout in performing wireless power transmission of the power transmitting apparatus to the power receiving apparatus is increased, and wireless power transmission can be performed without being aware of an positioning between the power receiving coil of the power receiving apparatus and the power transmitting coil of the power transmitting apparatus.

Further, the magnetic body 105 and the magnetic body 106 each are provided with a protruding portion in which a portion of the magnetic body protrudes, but the protruding portion may not be configured. By configuring in this manner, the similar effects of putting flexibility, and a degree of freedom into an layout between the apparatuses that perform wireless power transmission can be obtained.

A second exemplary embodiment will be described.

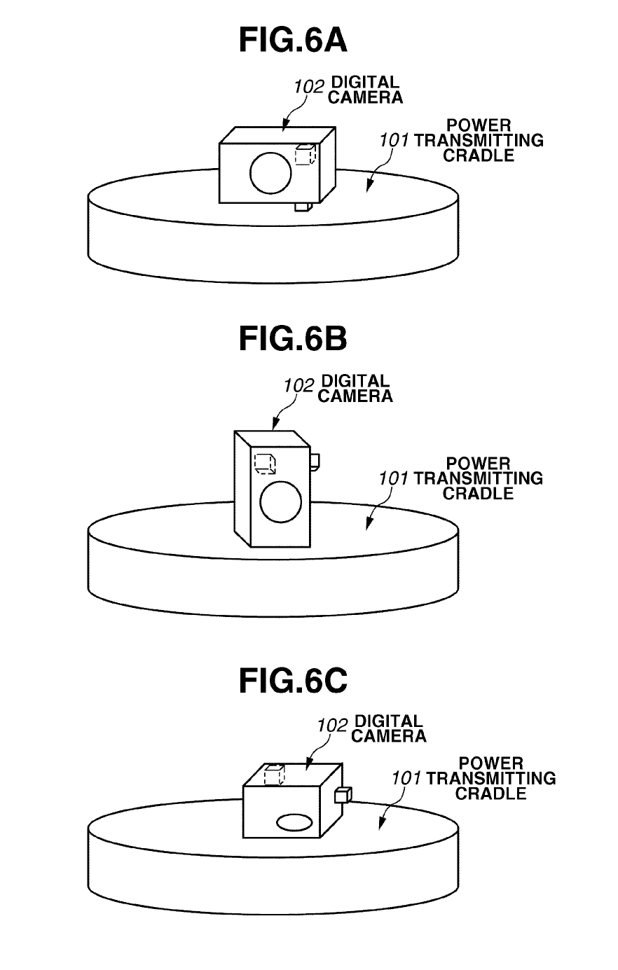

In the first exemplary embodiment, as illustrated in FIG. 5A through 5C, there has been illustrated an exemplary embodiment in which the magnetic body 106 loaded in the digital camera 102, and the magnetic body 105 loaded in the power transmitting cradle 101 are brought into close proximity to each other to perform wireless power transmission. In the present exemplary embodiment, as illustrated in FIG. 6A through 6C, an exemplary embodiment of a case where the digital camera 102 is arranged on the power transmitting cradle 101, so that the magnetic body 106 loaded in the digital camera 102, and the magnetic body 105 loaded in power transmitting cradle 101 are not brought into close proximity to each other, will be described. The configuration of the digital camera 102 in the present exemplary embodiment is similar to that of the digital camera 102 according to the first exemplary embodiment, but the digital camera 102 is assumed to further have wireless communication function for communicating with the power transmitting apparatus. In the present exemplary embodiment, the power transmitting cradle 101 is similar to the configuration of the first exemplary embodiment, and furthermore the chargeable face of the power transmitting cradle 101 according to the present exemplary embodiment is assumed to be equipped a sensor for detecting that a body is placed and a wireless communication function for communication between the power receiving apparatus and the power transmitting apparatus. Upon detecting that the object has been placed on the chargeable face, the power transmitting cradle 101 transmits a signal (polling signal) for inquiring the power receiving apparatus whether it is permitted to start wireless power transmission. Then, the power transmitting cradle 101 starts power transmission when there is a response to polling (when power transmission start is instructed).

As illustrated in FIGS. 6A through 6C, when the magnetic body 106 loaded in the digital camera 102, and the magnetic body 105 loaded in power transmitting cradle 101 are not in close proximity to each other, a distance between the magnetic body 105 and the magnetic body 106 is created, and an inductive coupling between the power transmitting and receiving coils is weakened. Therefore, wireless power transmission efficiency between the power transmitting cradle 101 and the digital camera 102 is lowered, so that the case where the wireless power transmission cannot be performed or the case where even if the wireless power transmission can be performed, continuing power transmission in this state may possibly result in considerable power loss, can be generated. Thus, the digital camera 102 performs the following control so that the power transmission is not performed while the wireless power transmission efficiency remains low.

In a case where layouts of the digital camera 102 are as illustrated in FIGS. 6A through 6C, they can be detected by the sensor unit 1613. Further, the digital camera 102 is assumed to mount a notification unit for prompting the user to change the layout of the digital camera. In the present exemplary embodiment, in a case where layout change of the digital camera is needed, the notification unit is assumed to notify the user accordingly by lighting up the LED lamp.

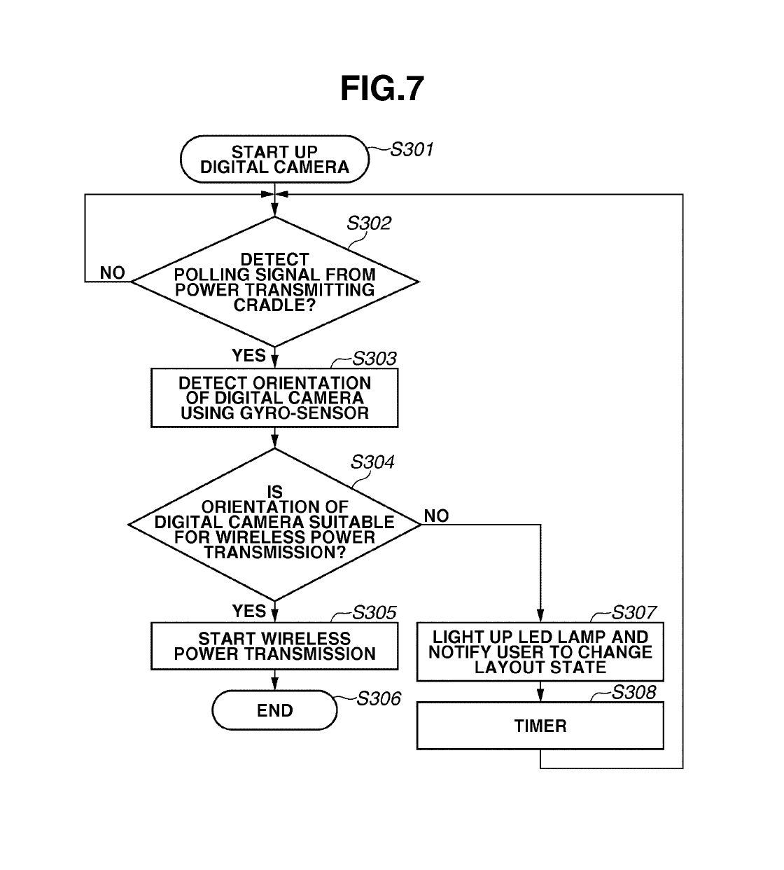

Hereinbelow, the control of the digital camera 102 will be described with reference to the flowchart of FIG. 7. The flowchart of FIG. 7 is realized by the control unit 1606 executing the control programs stored in the storage unit 1607, by performing calculation or processing of information, or control of each hardware. First, in step 301, the digital camera 102 is started up. Next, in step 302, the digital camera 102 determines whether a polling signal transmitted from the power transmitting cradle 101 has been detected (received). If the polling signal has been received (YES in step 302), in step 303, the sensor unit 1613 of the digital camera 102 detects an orientation of the digital camera 102. Next, in step 304, the control unit 1606 determines whether it is an orientation suitable for the wireless power transmission, from the detected orientation. Specifically, the control unit 1606 determines whether the magnetic body 106 is in contact with the power transmitting cradle 101 in the back surface, the right surface, and the bottom surface of the housing to which the magnetic body 106 is in close proximity (whether the digital camera 102 is placed on the back surface, the right surface, or the bottom surface).

If it is determined that the orientation of the digital camera is suitable for the wireless power transmission (YES in step 304) (if arranged as illustrated in FIG. 5A through 5C), in step 305, the control unit 1606 instructs the power transmitting cradle 101 to start the wireless power transmission using the wireless communication function. Then, when charging operation is completed, and power supply ends, in step 306, the control unit 1606 ends the operation.

Next, if it is determined that the orientation of the digital camera is not suitable for the wireless power transmission (NO in step 304), in step 307, the digital camera 102 notifies the user to change layout states by the display unit 1609 (the LED lamp is lit up according to the present exemplary embodiment). Then, in step 308, the user waits for a predetermined time period for performing layout change of the digital camera 102 and a timer ends. Then, the processing returns to step 302 where the control is performed to detect the polling signal from the power transmitting cradle.

In this manner, the digital camera 102 prompts the user to change the layout, until the layout state of the digital camera 102 on the power transmitting cradle 101 becomes an optimal layout state to perform wireless power transmission. In the present exemplary embodiment, a gyro sensor is used as a unit for detecting layout state of the digital camera 102, but a different sensor may be used as long as it is a sensor that can detect layout state of an object. Further, it may be configured to detect a charging power amount or change in impedance in the coil at the time of the wireless power transmission to detect that the magnetic body 106 is not appropriately in close proximity in performing wireless power transmission with the power transmitting cradle 101 in a housing face to which the magnetic body 106 is in close proximity. Alternatively, in a case where a transmission efficiency (power receiving efficiency) of the wireless power transmission performed by self apparatus falls below a predetermined value, it may be configured to detect that the magnetic body 106 is not in close proximity to the power transmitting cradle 101, in the housing face to which the magnetic body 106 is in close proximity. Alternatively, the wireless communication functions of the power-transmitting and power-receiving apparatuses may be configured to modulate an electromagnetic field or electric field which the power-transmitting and power-receiving apparatuses use for the power transmission to transmit or receive information. In that case, according to an intensity of the polling signal in the power receiving apparatus, it can be detected that the power-transmitting and power-receiving apparatuses are not appropriately in close proximity to each other in performing the wireless power transmission. As a unit for prompting the user to change layout state of the digital camera 102, light-up of the LED lamp has been used, but different unit such as outputting video signals for prompting change of layout state may be used to perform warning (prompting change of layout state).

Further, warning has been given in the digital camera 102 serving as a power receiving apparatus, but similar warning may be given in the power transmitting cradle 101 (power transmitting apparatus). For example, it may be configured such that the power transmitting cradle 101 gives warning in a case where a response to polling is not returned in spite that an object has been placed for a predetermined period of time. Alternatively, the power transmitting cradle 101 may obtain information about orientation via wireless communication from the digital camera 102, and give warning according to an orientation of the digital camera 102.

In the above-described example, a case where the digital camera executes the flowchart of FIG. 7 when being started up has been described, but when the digital camera is not started up (cases such as power-saving state), the digital camera will be started up after detecting the polling signal, and the processing from step 303 and onward may be performed. Alternatively, it may be configured such that only necessary functions can be operated even when the digital camera is not started up (cases such as power-saving state), or operation of the present exemplary embodiment is performed, according to a predetermined momentum (for example, receiving of polling signal).

According to the present exemplary embodiment, warning can be notified of the user in such a manner as to prevent the power transmission from being performed while the wireless power transmission efficiency remains low.

A third exemplary embodiment will be described.

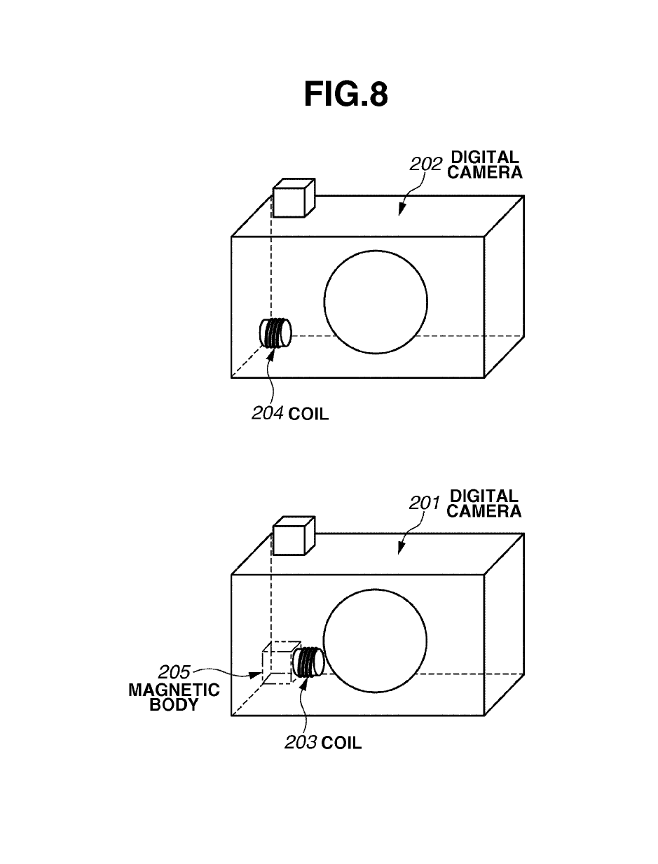

In the first exemplary embodiment, the second exemplary embodiment, power transmitting and receiving between the power transmitting cradle 101 and the digital camera 102 has been described. In the present exemplary embodiment, as illustrated in FIG. 8, a case of performing the wireless power transmission between a digital camera 201 on the power transmitting side, and a digital camera 202 on the power receiving side is considered.

The digital camera 201 illustrated in FIG. 8 is equipped with a coil 203, and the digital camera 202 is equipped with a coil 204. The digital camera 201 is loaded with a magnetic body 205 formed of a rectangular solid body between the coil 203 and the housing, and the magnetic body 205 is arranged to be in contact with a plurality of faces of the housing of the digital camera 201. FIG. 8 illustrates an example in which the magnetic body 20 is in contact with the back surface, the right surface, and the bottom surface of the housing, but may be in contact with (in close proximity to) other faces. A magnetic body is not loaded on the coil 204 with which the digital camera 202 is equipped. The digital camera 201 is similar to the configuration illustrated in FIG. 16B. The digital camera 202 is similar to the configuration illustrated in FIG. 16B except that the power receiving unit 1611 does not have a magnetic body.

A case of performing wireless power transmission between the digital camera 201 having the above-described structure and the digital camera 202 is considered. In the example of FIG. 8, the magnetic body 205 of the digital camera 201 is in contact with the back surface, the right surface, and the bottom surface of the housing. Therefore, if the coil (the right surface of the digital camera 202) of the digital camera 202 is arranged at a position at which the back surface, the right surface, and the bottom surface of the digital camera 201 is facing the magnetic body 205, wireless power transmission having less power loss and favorable transmission characteristics can be performed.

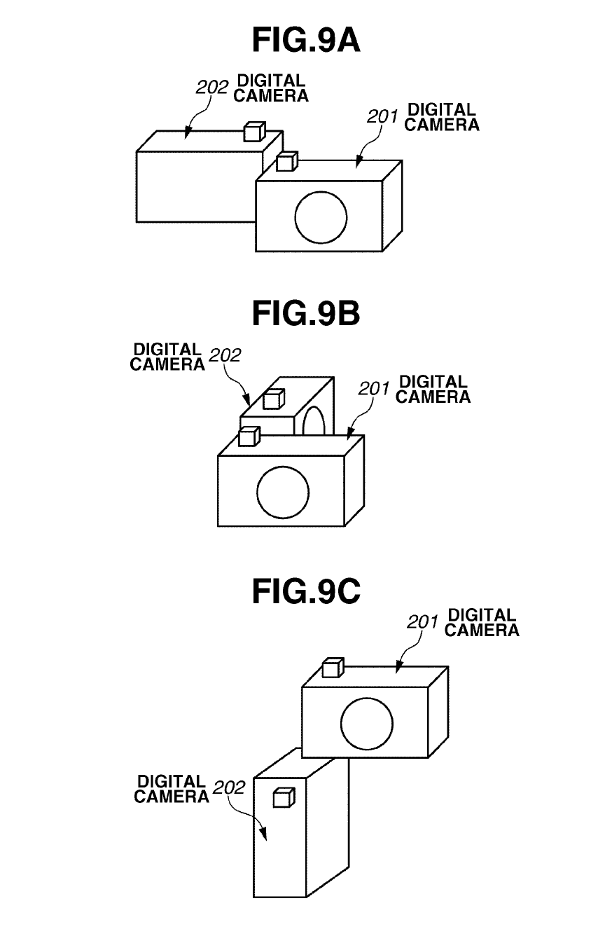

FIGS. 9A through 9C are layout examples in which the digital camera 201 and the digital camera 202 can perform wireless power transmission with favorable transmission characteristics. In FIG. 9A, the digital camera 202 is oriented backwards, and the right surface of the digital camera 201 (where the magnetic body 205 is arranged) and the right surface of the digital camera 202 (where the coil 204 is arranged) are facing each other. In FIG. 9B, the back surface of the digital camera 201 (where the magnetic body 205 is arranged) and the right surface of the digital camera 202 (where the coil 204 is arranged) are facing each other. In FIG. 9C, the digital camera 202 is standing, and the bottom surface of the digital camera 201 (where the magnetic body 205 is arranged) and the right surface of the digital camera 202 (where the coil 204 is arranged) are facing each other.

As described above, by loading the magnetic body between the coil and the housing so that a plurality of faces of the magnetic body formed of the rectangular solid body comes into contact with or into close proximity to a plurality of face of the housing of the digital camera 201, it becomes possible to perform wireless power transmission, without the coils on the power transmitting side and on power receiving side being facing each other. In other words, by loading the magnetic body between the coil and the housing, so that the plurality of faces of the magnetic body formed of the rectangular solid body is facing the plurality of faces of the housing of the digital camera 201, it becomes possible to perform wireless power transmission, without the coils on the power transmitting side and on the power receiving side being facing each other. Therefore, flexibility can be put into layout between the apparatuses that perform wireless power transmission. Further, a shape of the magnetic body may not necessarily be a rectangular solid body, but if a shape of the magnetic body loaded on the housing is conformed to a shape of the housing for the wireless power transmission, the magnetic body can be loaded so that the plurality of faces of the magnetic body comes into contact with or into close proximity to the plurality of faces of the housing. In other words, if a shape of the housing is a rectangular solid body as illustrated in FIG. 8, layout of the magnetic body can be facilitated when the magnetic body is formed of the rectangular solid body.

A fourth exemplary embodiment will be described.

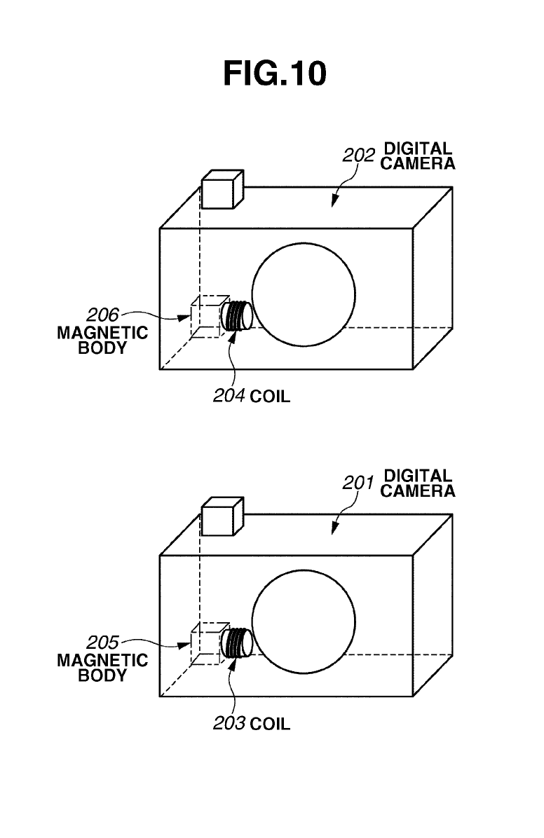

In the third exemplary embodiment, the magnetic body 205 has been loaded to the coil 203 of the digital camera 201 on the power transmitting side. However, in the present exemplary embodiment, as illustrated in FIG. 10, both the digital camera 201 on the power transmitting side and the digital camera 202 on the power receiving side load the magnetic bodies to the coils. In the digital camera 202 on the power receiving side, the magnetic body 206 formed of the rectangular solid body is loaded between the coil 204 and the housing, and the magnetic body 206 is arranged to come into contact with a plurality of faces of the housing of the digital camera 202. FIG. 10 illustrates an example in which the magnetic body 206 is in contact with the back surface, the right surface, and the bottom surface of the housing, and may be in contact with (in close proximity to) other faces. The magnetic body 206 may not necessarily come into contact with the housing, but as the distance from the housing increases, the transmission characteristics deteriorates, and it is advantageous that the magnetic body 206 comes into contact with or close proximity to the housing.

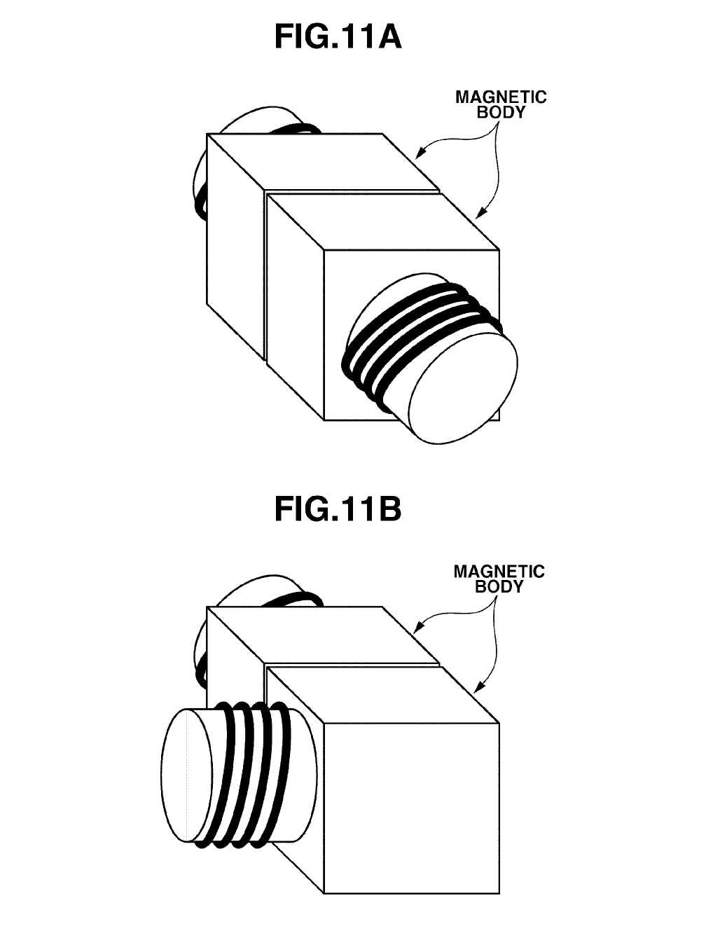

In that case, in a case where the coils are facing each other as illustrated in FIG. 11A, an inductive coupling between the coils is strengthened by the magnetic body causing the magnetic field to concentrate, whereby favorable power transmission characteristics is obtained. Even in a state where the coils are not facing each other, as illustrated in FIG. 11B, an inductive coupling between the coils is strengthened by the magnetic bodies forming the magnetic paths, and as a result, favorable power transmission characteristics will be similarly obtained.

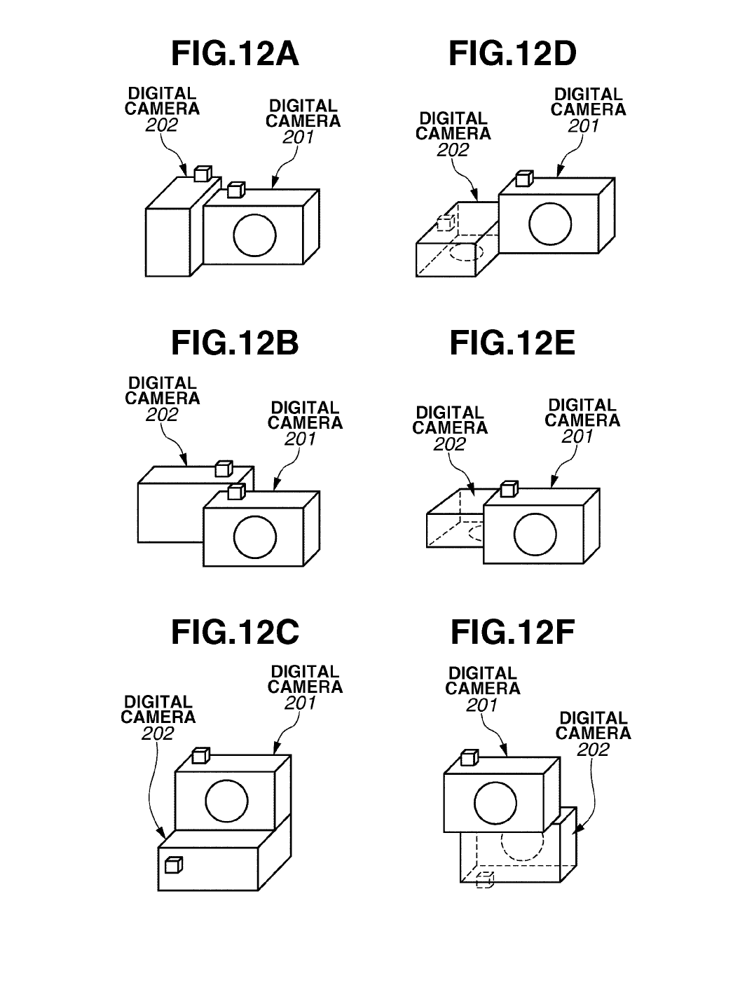

Therefore, by loading the magnetic bodies formed of the rectangular solid bodies to the coils on the power transmitting side and on the power receiving side, layouts of the digital camera 201 and the digital camera 202 that perform wireless power transmission, for example, as illustrated in FIGS. 12A through 12F become possible. In FIG. 12A, the digital camera 202 is oriented sideways, and the right surface of the digital camera 201 (where the magnetic body 205 is arranged) and the back surface of the digital camera 202 (where the magnetic body 206 is arranged) are facing each other. In FIG. 12B, the digital camera 202 is oriented backward, and the back surface of the digital camera 201 (where the magnetic body 205 is arranged) and the back surface of the digital camera 202 (where the magnetic body 206 is arranged) are facing each other. In FIG. 12C, the digital camera 202 is laid, and the bottom surface of the digital camera 201 (where the magnetic body 205 is arranged) and the back surface of the digital camera 202 (where the magnetic body 206 is arranged) are facing each other. In FIG. 12D, the digital camera 202 is laid, and the right surface of the digital camera 201 (where the magnetic body 205 is arranged) and the bottom surface of the digital camera 202 (where the magnetic body 206 is arranged) are facing each other. In FIG. 12E, the digital camera 202 is laid, the back surface of the digital camera 201 (where the magnetic body 205 is arranged) and the bottom surface of the digital camera 202 (where the magnetic body 206 is arranged) are facing each other. In FIG. 12F, the digital camera 202 is standing upside down, and the bottom surface of the digital camera 201 (where the magnetic body 205 is arranged) and the bottom surface of the digital camera 202 (where the magnetic body 206 is arranged) are facing each other.

As described above, by loading the magnetic bodies formed of the rectangular solid bodies to the coils on the power transmitting side and on the power receiving side, favorable wireless power transmission characteristics can be obtained, without the coils between the power-transmitting and power-receiving apparatuses being facing each other. Further, by loading rectangular magnetic bodies to the coils on the power transmitting side and on the power receiving side, greater flexibility can be put into layouts of the apparatuses than the case in the third exemplary embodiment.

A fifth exemplary embodiment will be described.

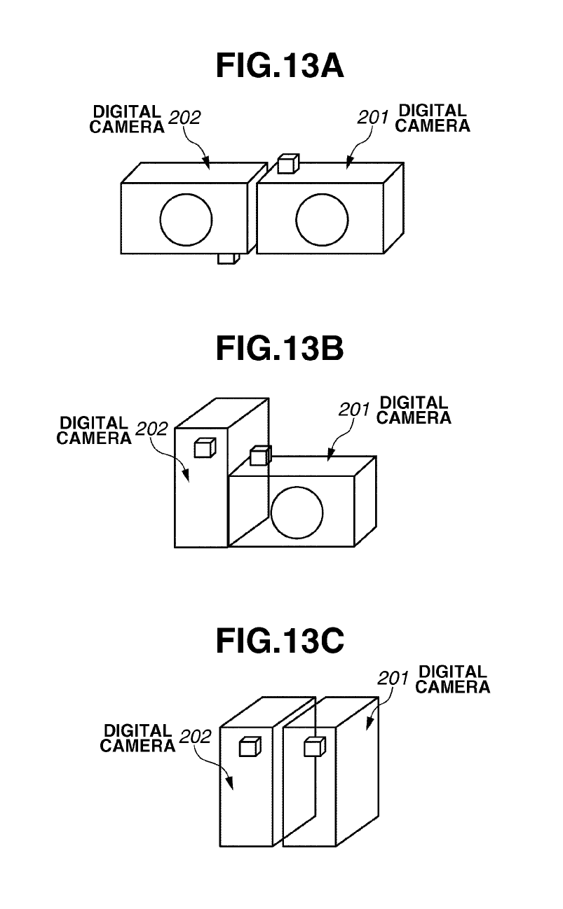

In the third exemplary embodiment, a case of performing wireless power transmission between the digital cameras equipped with the wireless power transmission function is considered. In the present exemplary embodiment, in the configuration of the wireless power transmission system according to the third exemplary embodiment, exemplary embodiment of a case where the magnetic body 205 loaded on the digital camera 201 is not in contact with the coil 204 loaded in the digital camera 202 as illustrated in FIGS. 13A through 13C, will be described. However, it is based on the premise that the digital camera 201 and the digital camera 202 are placed on a desk.

As illustrated in FIGS. 13A through 13C, in a case where the magnetic body 205 loaded on the digital camera 201 and the coil 204 loaded on the digital camera 202 are arranged not to come into close proximity to each other, the inductive coupling between the coils will be weakened. Therefore, the wireless power transmission efficiency between the digital camera 201 and the digital camera 202 will be lowered, and a case where the wireless power transmission cannot be performed could take place, or even if the wireless power transmission can be performed, when continuing the power transmission in this state, considerable power loss could take place.

The digital camera 201 and the digital camera 202 are assumed to be mounted with a gyro sensor that detects an angle or an angular velocity of an object, and a close short range wireless communication function for performing wireless communications. In the present exemplary embodiment, short range wireless communication is assumed to employ a near field communication (NFC). The digital camera 201 and the digital camera 202, in a case where layouts of the digital camera 201 and the digital camera 202 become as illustrated in FIG. 13A through 13C, each layout state can be detected by the built-in gyro sensor, and can be notified to the partner. Further, the digital camera 201 is assumed to be mounted with a notification unit which prompts the user to change layout of the digital camera. In the present exemplary embodiment, in a case where layout change of the digital camera is necessary, it is assumed to notify the user accordingly by lighting up the LED lamp. The digital camera 201 has a mode of functioning as a power transmitting apparatus, and supplies power to other apparatus via the wireless power transmission.

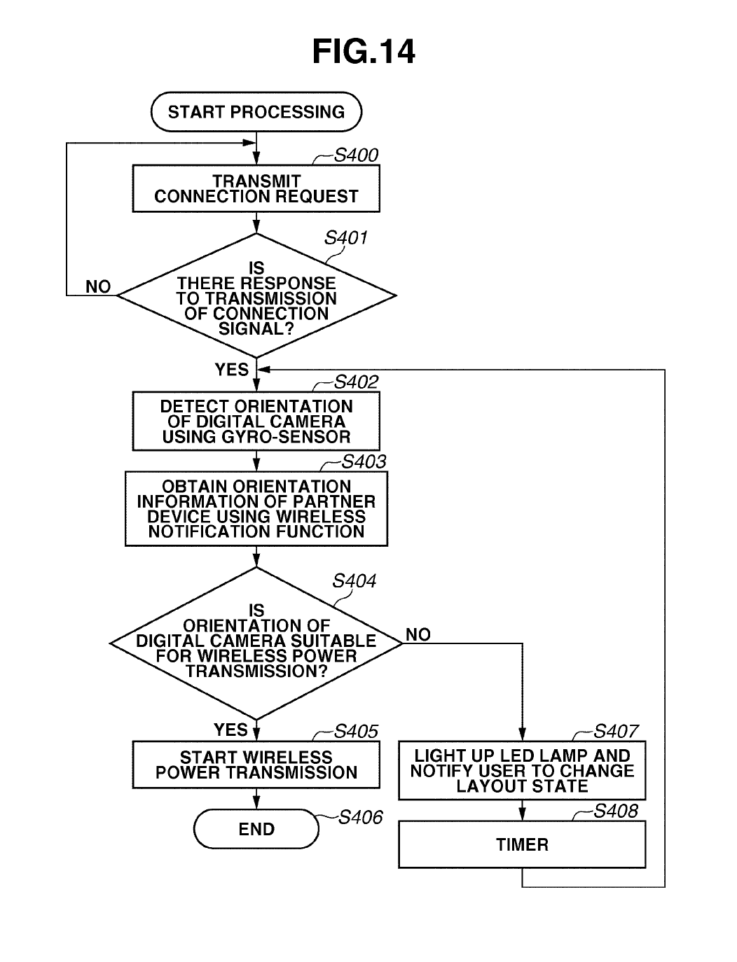

Hereinbelow, the control of the digital camera 201 will be described using the flowchart of FIG. 14. The flowchart of FIG. 14 is realized by the control unit executing control programs stored in the digital camera 201, and performing calculation or processing of information, or performing control of each hardware. First, when a mode of functioning as a power transmitting apparatus of the digital camera 201 is started up, the digital camera 201 starts the processing. In step 400, the digital camera 201, upon starting the processing, starts up the short range wireless communication, and transmits connection request of short range wireless communication. In step 401, the digital camera 201 determines whether there is a response to the connection request from the digital camera 202. If there has been a response to the connection request (YES in step 401), the digital camera 201 can recognize to have come into close proximity to the digital camera 202 in an enabled communication area via the short range wireless communication. Next, in step 402, the digital camera 201 detects an orientation of the digital camera 201 by the built-in gyro sensor. Next, in step 403, the digital camera 201 obtains information about orientation of the digital camera 202 from the digital camera 202 as the partner apparatus, using the short range wireless communication function.

Next, in step 404, the control unit of the digital camera 201 determines whether the layout state is suitable for the wireless power transmission from layout state of the digital camera 201 and the digital camera 202. In other words, the control unit of the digital camera determines whether layout state with respect to the partner apparatus are as illustrated in FIGS. 13A through 13C. If it is determined that layout state with respect to the partner apparatus is suitable for the wireless power transmission (YES in step 404) (case of layout states illustrated in FIGS. 9A through 9C), in step 405, the control unit notifies the partner apparatus to start the wireless power transmission using the short range wireless function. When power supply ends, in step 406, the control unit ends the operation. Next, if it is determined that layout state is not suitable for the wireless power transmission (NO in step 404), in step 407, the digital camera 201 blinks the LED lamp, and notifies the user to change layout state. Alternatively, the control unit may give warning the partner apparatus that layout state is not suitable for the wireless power transmission using the short range wireless communication. Then, in step 408, the user waits for a predetermined time period for performing layout change of the digital camera 201 or the digital camera 202. When a timer ends, the processing returns to step 402 where the control unit performs control to detect layout state using the gyro sensor. In this manner, the control unit prompts the user to change the layout, until the layout state of the digital camera 201 and the digital camera 202 become the best layout state for performing the wireless power transmission.

In the present exemplary embodiment, the gyro sensor as a unit for detecting layout state of the digital camera 201 has been used, but other sensor may be used as long as it is a sensor that can detect layout state of an object. Further, it may be configured to detect that self apparatus and other apparatus are not appropriately arranged in performing the wireless power transmission in a case where transmission efficiency (power receiving efficiency) of the wireless power transmission performed by self apparatus falls below a predetermined value. Further, it may be configured to detect change in impedance in the coil from other apparatus, after starting the wireless power transmission, and to detect that self apparatus is not appropriately in close proximity to the other apparatus in performing the wireless power transmission with the other apparatus. Alternatively, in a case where transmission efficiency (power transmitting and receiving efficiency) of the wireless power transmission performed by self apparatus falls below the predetermined value, it may be configured to detect that self apparatus is not appropriately in close proximity to the other apparatus in performing wireless power transmission with the other apparatus. Further, it may be configured to detect that self apparatus is not appropriately in close proximity to the other apparatus in performing wireless power transmission with other apparatus, based on the close proximity wireless communication. It may be configured to detect, for example, whether communication with the other apparatus through the short range wireless communication is enabled, or that other apparatus is not appropriately arranged in performing the wireless power transmission based on receiving intensity of the short range wireless communication. By configuring in this manner, warning can be given to the user, without the need to obtain information such as orientation from the other apparatus.

Further, an obtaining unit for obtaining layout state of the digital camera 202 may use wired communication function instead of the wireless communication function. Further, lighting up the LED lamp is used as a unit for prompting the user to change layout state of the digital camera 102, but separate unit using video information or the like may be applied. Further, in the present exemplary embodiment, descriptions have been provided based on the configuration of the wireless power transmission system according to the third exemplary embodiment, and notification to prompt change of layout state may be performed also in the configuration of the wireless power transmission system according to the fourth exemplary embodiment. For example, in the wireless power transmission system according to the fourth exemplary embodiment, if it is determined that the wireless power transmission system is in layout state with low wireless power transmission efficiency, it is possible to notify the user to change layout of the digital camera 201 or the digital camera 202.

Information about orientation has been obtained from the other apparatus, but it may be configured to additionally obtain information about a face where the coil is arranged (a face which is brought into close proximity to an opposing apparatus when the wireless power transmission is performed). By configuring in this manner, even if the coil layout location of the other apparatus is not known, it can be determined whether layout state is appropriate in performing the wireless power transmission, based on an orientation of self apparatus, an orientation of the other apparatus, and layout location of the coils of the other apparatus. Although the digital camera 201 has given warning, a configuration in which the digital camera 202 gives warning to the user based on notification from the digital camera 201 may be used. Alternatively, a configuration in which the power receiving apparatus side performs the above-described processing in similar manner may be used.

According to the present exemplary embodiment, warning can be notified to the user to ensure that the power transmission be not performed while the wireless power transmission efficiency remains low.

A sixth exemplary embodiment will be described.

In the present exemplary embodiment, a shape of the magnetic body loaded to the coil will be described. In the first exemplary embodiment through the fifth exemplary embodiment, a case where the magnetic body formed of the rectangular solid body is loaded to the coil has been described. However, since the magnetic field concentrates inside the magnetic body, a shape of the magnetic body may be other shape.

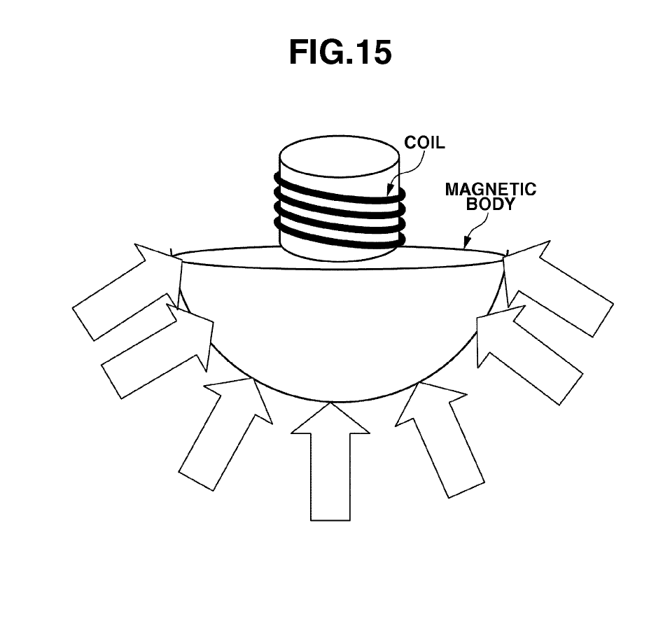

For example, a case where hemispherical magnetic body is loaded to the coil as illustrated in FIG. 15 is considered. In that case, even when the other coil is arranged in different directions as indicated by arrows in FIG. 15, instead of being arranged at an opposing position, favorable power transmission characteristics will be obtained. In this manner, no matter what shape of the magnetic body loaded to the coil it may be, the magnetic field concentrates inside the magnetic body, and favorable power transmission characteristics will be obtained. If the shape of the magnetic body loaded to the coil is arranged in contact with (in close proximity to) a plurality of faces of the housing of the apparatus having the built-in coil or along a curved surface, it becomes possible to perform short range wireless power transmission with the partner apparatus from a plurality of directions, even when the coils on the power transmitting side and on the power receiving side are not opposed to each other. Therefore, flexibility, and a degree of freedom can be put into the layout between the apparatuses that perform short range wireless power transmission.

Even if the magnetic body shape is complicated, the above-described characteristics can be obtained, and therefore, for example, the above-described magnetic body may be replaced with wireless device housing. Further, descriptions have been provided assuming the wireless power transmission system, and the structure can be also applied in the wireless communication, as a technique for efficiently performing communications, without causing the coils to be facing each other. For example, flexibility, and a degree of freedom can be put into an layout between the apparatuses that perform wireless communication of NFC, using the configurations in the above-described exemplary embodiments.

A seventh exemplary embodiment will be described.

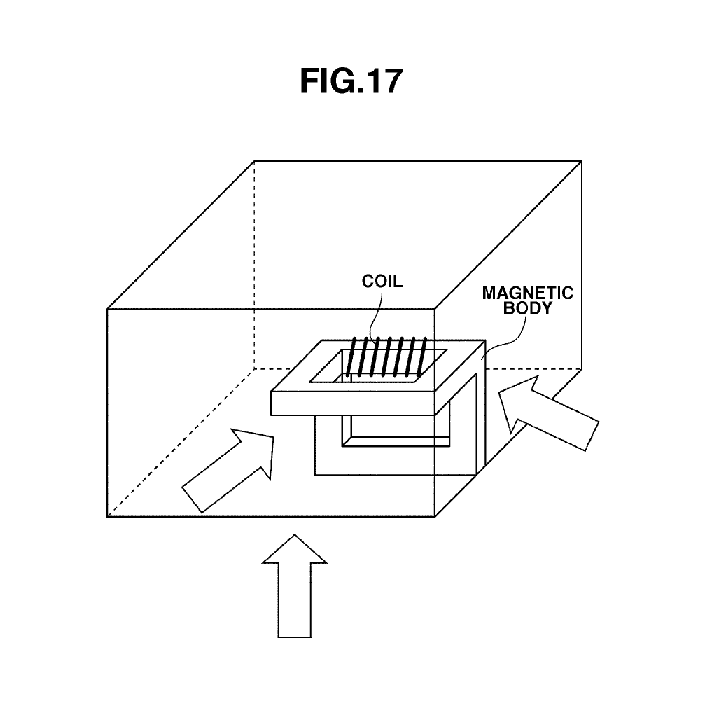

In the sixth exemplary embodiment, as a shape of the magnetic body loaded to the coil, a shape of hemispherical magnetic body as illustrated in FIG. 15 has been described. In the present exemplary embodiment, exemplary embodiment in a case where a shape of the magnetic body loaded to the coil is assumed to be a shape as illustrated in FIG. 17 will be described.

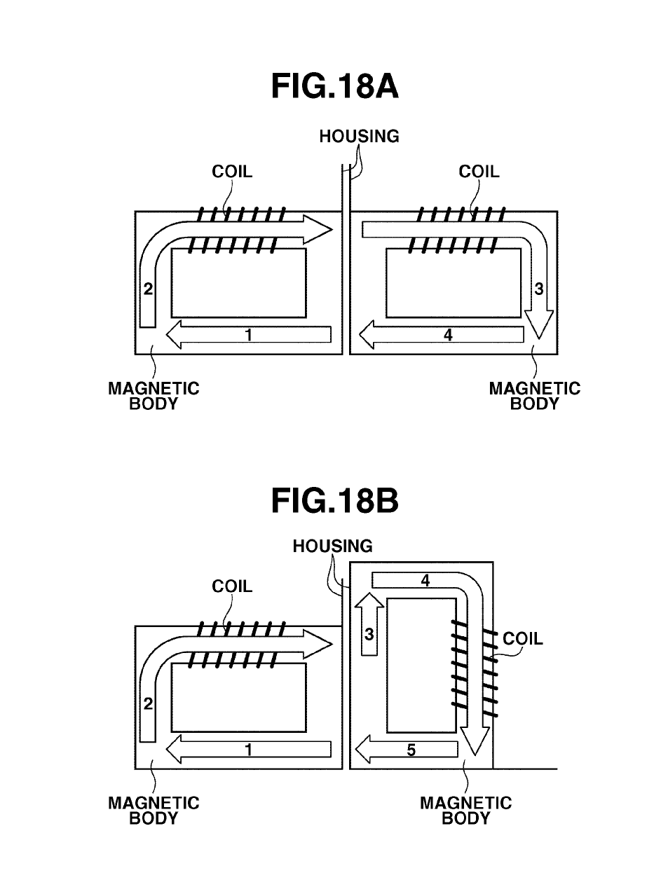

As described above, since the magnetic fluxes can be concentrated inside the magnetic bodies, when the magnetic bodies are loaded between the coils on the power transmitting side and on the power receiving side, coupling between the coils can be strengthened, whereby power can be transmitted efficiently. In other words, by loading the magnetic bodies, the magnetic fluxes which penetrate through the coil on the power transmitting side and the coil on the power receiving side can be increased. Thus, as a shape of the magnetic body loaded to the coil, a shape as illustrated in FIG. 17 is considered. If a magnetic body in a shape as illustrated in FIG. 17 is loaded in the same state to each of the coil on the power transmitting side and the coil on the power receiving side, favorable power transmission will be obtained even when the other coil is arranged in different directions as indicated by arrows of FIG. 17. Even if layouts of the coils and the magnetic bodies become, for example, as illustrated in FIGS. 18A and 18B, the magnetic bodies become able to form closed loops as indicated by arrows. For example, in FIG. 18A, closed loop is formed by route as indicated by arrows 1, 2, 3, and 4 in the figure. In FIG. 18B, closed loop is formed by route as indicated by arrows 1, 2, 3, 4, and 5 in the figure. It becomes possible to strengthen coupling between the coils by the magnetic fluxes passing through closed magnetic paths which become the closed loops.

As described above, as illustrated in FIG. 17 and FIGS. 18A, 18B, the magnetic flux generated between the coil on the power transmitting side and the coil on the power receiving side, pass through the closed magnetic paths of closed loops configured using the magnetic bodies, whereby strong coupling between the coils is obtained, and efficient power transmission becomes possible. A shape of the magnetic body forming the closed magnetic path of the closed loop loaded to the coils, even a shape other than FIG. 17, can realize the wireless power transmission. Since the magnetic body is arranged on each of the power transmitting side and the power receiving side, strictly speaking, the magnetic body will be interrupted at boundary portion of the housing on the power transmitting side and on the power receiving side. Further, it is assumed that the housings on the power transmitting side and on the power receiving side are slightly spaced, depending on status during usage. However, as a matter of course, since the magnetic flux passes through an air, and the housings on the power transmitting side and on the power receiving side are in close proximity to each other, even the magnetic body in such a state is referred to as “closed loop is configured” in the specification. Further, layout location of the coil is not limited to locations described in FIG. 17, and FIGS. 18A and 18B in the present exemplary embodiment, but the coil of each of the power transmitting side and the power receiving side only needs to be arranged, in the closed magnetic path formed by the above-described magnetic body.

### Other Exemplary Embodiments

In the above-described exemplary embodiments, descriptions have been provided assuming the wireless power transmission system, but the structure can be applied as a technique for efficiently performing communications in the wireless communication, without causing the coils to be facing each other.

Further, the coil illustrated in the figure described in the exemplary embodiments of the above-described first through seventh exemplary embodiments is formed by winding an electric wire on the magnetic body. However, a form of the coil may be not only the above-described configuration but also, for example, a coil formed by a pattern on a printed board. In other words, as long as it is the one which operates as the coil, any form is acceptable. Further, in a case of the coil formed by a pattern on the above-described printed board, it becomes possible to obtain the effects similar to those in the first through seventh exemplary embodiments, by arranging the magnetic body on a substrate on which the coil is formed. In this case, a portion (protruding portion) of the magnetic body may exist, or even if a protruding portion does not exist inside the coil formed by a pattern, it is possible to obtain similar effects, though coupling between the coils is weakened.

According to the above-described present exemplary embodiment, flexibility, and a degree of freedom of apparatus layout when power transmitting and receiving is performed can be improved.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-131054 filed Jun. 8, 2012, which is hereby incorporated by reference herein in its entirety.

What is claimed is:

1. A wireless power transmission apparatus configured to perform wireless power transmission with another apparatus, the wireless power transmission apparatus comprising:
a coil configured to perform wireless power transmission; and
a magnetic body configured to be arranged such that at least a portion thereof penetrates an interior of the coil,
wherein a plurality of faces of the magnetic body is arranged to be facing a plurality of faces of a housing of the wireless power transmission apparatus.

2. The wireless power transmission apparatus according to claim 1, wherein the arrangement where a plurality of faces of the magnetic body is facing a plurality of faces of a housing of the wireless power transmission apparatus is a layout where each of a plurality of faces of the magnetic body is in contact with or in close proximity to a plurality of faces of the housing of the wireless power transmission apparatus.

3. The wireless power transmission apparatus according to claim 1, wherein the magnetic body comprises a rectangular solid body and a protruding portion protruding from a portion of the rectangular solid body, and the coil circumscribes the protruding portion.

4. The wireless power transmission apparatus according to claim 1, further comprising:
a detection unit configured to detect an orientation of the wireless power transmission apparatus; and
a notification unit configured to perform a predetermined notification to prompt a layout change of the wireless power transmission apparatus, according to the detected orientation and the plurality of faces of a housing of the wireless power transmission apparatus which the plurality of faces of the magnetic body is facing.

5. The wireless power transmission apparatus according to claim 1, further comprising:
an obtaining unit configured to obtain information about an orientation of the other apparatus; and
a notification unit configured to perform a predetermined notification to prompt a layout change of the wireless power transmission apparatus, according to the obtained information and the plurality of faces of a housing of the wireless power transmission apparatus which the plurality of faces of the magnetic body is facing.

6. The wireless power transmission apparatus according to claim 4, further comprising an obtaining unit configured to obtain information about an orientation of the other apparatus,
wherein the notification unit performs the predetermined notification, according to the obtained information and an orientation of the wireless power transmission apparatus.

7. The wireless power transmission apparatus according to claim 1, further comprising:
a detection unit configured to detect an orientation of the wireless power transmission apparatus; and
a notification unit configured to notify the other apparatus of the detected orientation, in order for the other apparatus to perform a predetermined notification that prompts a layout change of the wireless power transmission apparatus, according to an orientation of the wireless power transmission apparatus.

8. The wireless power transmission apparatus according to claim 1, further comprising:
a communication unit configured to perform short range wireless communication with the other apparatus; and
a notification unit configured to perform a predetermined notification that prompts layout change of the wireless power transmission apparatus, in accordance with communication by the communication unit.

9. The wireless power transmission apparatus according to claim 1, further comprising a notification unit configured to perform a predetermined notification that prompts a layout change of the wireless power transmission apparatus, based on a value selected from power receiving efficiency of wireless power transmission and impedance of the coil.

10. The wireless power transmission apparatus according to claim 1, further comprising a unit configured to perform an action selected from requesting the other apparatus for start of wireless power transmission and notifying the other apparatus for start of wireless power transmission, according to layout states of the wireless power transmission apparatus and the other apparatus.

11. The wireless power transmission apparatus according to claim 1, wherein the wireless power transmission is performed using a method selected from electromagnetic induction method and a magnetic field resonance method.

12. The wireless power transmission apparatus according to claim 1, wherein a corner of a housing of the wireless power transmission apparatus and a corner of the magnetic body are arranged in contact with or in close proximity to each other.

13. The wireless power transmission apparatus according to claim 1, wherein a case of performing the wireless power transmission while either face of a plurality of faces that is in contact with or in close proximity to a plurality of faces of the magnetic body while facing each other among faces of a housing of the wireless power transmission apparatus, is in contact with the other apparatus has higher transmission efficiency than a case of performing the wireless power transmission while either face other than a plurality of faces that is in contact with or in close proximity to a plurality of faces of the magnetic body among faces of the housing, is in contact with the other apparatus.

14. The wireless power transmission apparatus according to claim 13, wherein the transmission efficiency is defined based on a charging amount per unit of time or a time until full-charging is reached.

15. The wireless power transmission apparatus according to claim 1, wherein a face which is facing the housing of the magnetic body is larger than the coil.

16. A wireless power transmission apparatus comprising:
a coil configured to perform wireless power transmission; and
a magnetic body configured to be arranged such that at least a portion thereof is arranged to penetrate through an interior of the coil,
wherein a face of the magnetic body which is in contact with or in close proximity to a housing of the wireless power transmission apparatus is larger than the coil.

17. A wireless power transmission system comprising:
the wireless power transmission apparatus according to claim 1; and
an other apparatus configured to perform wireless power transmission with the wireless power transmission apparatus.

18. A wireless power transmission system comprising:
the wireless power transmission apparatus according to claim 16; and
an other apparatus configured to perform wireless power transmission with the wireless power transmission apparatus.

19. A wireless power transmission system comprising:
the wireless power transmission apparatus according to claim 1; and
a second wireless power transmission apparatus comprising
a second coil configured to perform wireless power transmission; and
a second magnetic body configured to be arranged such that at least a portion thereof is arranged to penetrate through an interior of the second coil,
wherein a face of the second magnetic body which is in contact with or in close proximity to a housing of the second wireless power transmission apparatus is larger than the second coil.

20. A wireless communication apparatus configured to perform wireless communication with another apparatus, the apparatus comprising:
a coil configured to perform wireless communication; and
a magnetic body configured to be arranged such that at least a portion thereof penetrates through an interior of the coil,
wherein a plurality of faces of the magnetic body is arranged to be facing a plurality of faces of a housing of the wireless communication apparatus.

21. A wireless communication apparatus configured to perform wireless communication with another apparatus, the apparatus comprising:
a coil configured to perform wireless communication; and
a magnetic body configured to be arranged such that at least a portion thereof penetrates through an interior of the coil,
wherein a face of the magnetic body which is in contact with or in close proximity to a housing of the wireless communication apparatus is larger than the coil.

22. A wireless power transmission apparatus comprising:
a housing of the wireless power transmission apparatus;
a first coil arranged within the housing, for performing wireless power transmission; and
a magnetic body,
wherein, if a first face of the housing not facing the first coil is facing a second coil of other wireless power transmission apparatus, the magnetic body is arranged so that wireless power transmission can be performed between the first coil and the second coil.

23. A wireless power transmission apparatus comprising:
a coil configured to perform wireless power transmission; and
a magnetic body configured to be arranged such that at least a portion thereof penetrates through an interior of the coil,
wherein a face of the magnetic body which is in contact with or in close proximity to a housing of the wireless power transmission apparatus is larger than the coil.

24. The wireless power transmission apparatus according to claim 1, wherein the magnetic body, a portion of which is located inside the coil, comprises a closed loop with a magnetic body arranged within a wireless power transmission apparatus facing thereto.
